(19) United States
(12) Patent Application Publication
(10) Pub. No.: US 2019/0354906 A1
(43) Pub. Date: Nov. 21, 2019

(54) METHODS AND SYSTEMS FOR EXECUTING BUSINESS LOGIC RELATED TO PHYSICAL SPACES AND ASSOCIATED DEVICES

(71) Applicant: MICROSOFT TECHNOLOGY LICENSING, LLC, Redmond, WA (US)

(72) Inventors: Alina Mihaela STANCIU, Redmond, WA (US); Gregory Christopher John VANDENBROUCK, Bellevue, WA (US); Andres Carlo PETRALLI, Redmond, WA (US); Hubert VAN HOOF, Redmond, WA (US)

(21) Appl. No.: 15/985,513

(22) Filed: May 21, 2018

(51) Int. Cl. G06Q 10/06

(52) U.S. Cl. CPC G06Q 10/0631

(57) ABSTRACT

Executing business logic for an entity of a relational structure having a plurality of entities includes obtaining data associated with a first entity of the plurality of entities of the relational structure. The obtained data at least partially causes actuation of a trigger. Based on actuation of the trigger, particular business logic associated with the trigger is identified. The business logic is executed for a second entity that is related to the first entity within the relational structure, by using the obtained data associated with the first entity as a parameter value for execution of the business logic for the second entity. A computing action is performed based on a result of executing the business logic for the second entity.

### BACKGROUND

Computer systems and related technology affect many aspects of society. Indeed, the computer system's ability to process information has transformed the way we live and work. Computer systems now commonly perform a host of tasks (e.g., word processing, scheduling, accounting, etc.) that prior to the advent of the computer system were performed manually. More recently, computer systems have been coupled to one another and to other electronic devices to form both wired and wireless computer networks over which the computer systems and other electronic devices can transfer electronic data.

As computing systems have become cheaper and smaller, they have begun to proliferate to almost all areas of life. For example, Internet of Things (IoT) devices are network-connected devices that are placed in many physical spaces to enable people to interact with and gather information about their environment. For example, offices or homes may include numerous IoT devices that can be used to control locks, to manage indoor climate and receive climate information, to manage lighting and receive lighting information, to open and close doors, to perform cleaning functions, to control audio and/or video equipment, to provide voice interaction, to provide security and monitoring capabilities, etc. As such, IoT devices can process and generate vast amounts of information. Notably, IoT devices are not limited to use in structures such as offices or homes. For example, IoT devices may be used to track any manner of physical items (including, for example, animals such as livestock or pets), to monitor health of people or animals, and so forth.

As IoT devices proliferate, it is becoming increasingly difficult to manage the devices and their users, and to process the data they generate. Notably, it may often be difficult to intuitively manage and group such devices (e.g., based on physical space or synergistic functionality), to efficiently control these devices (including controlling user access), to efficiently access data associated with these devices, and/or to efficiently process data associated with these devices. For example, managing IoT devices could involve storing large amounts of data associated with the physical environment in which they exist (e.g., buildings with their floors, rooms, room types, objects the rooms, etc.). Similarly, large numbers of devices may also result in enormous amounts of generated data (e.g., sensor data) that may be difficult to manage and access, and to link to the physical environment.

### BRIEF SUMMARY

At least some embodiments described herein relate to methods, systems, and computer program products for executing business logic for an entity of a relational structure having a plurality of entities. Embodiments may include obtaining data associated with a first entity of the plurality of entities of the relational structure. The obtained data at least partially causes actuation of a trigger. Embodiments may further include, based on actuation of the trigger, identifying particular business logic associated with the trigger. Embodiments may further include executing the business logic for a second entity that is related to the first entity within the relational structure, by using the obtained data associated with the first entity as a parameter value for execution of the business logic for the second entity, and performing a computing action based on a result of executing the business logic for the second entity.

Accordingly, an environment for executing business logic for one or more entities may allow for efficiently processing and effectively utilizing data associated with one or more devices related to a space (e.g., physical space or virtual space). Moreover, the environment may allow for chaining one or more triggers, items of business logic, and/or actions, such that complex processing of such data can be utilized. In addition, business logic, and/or computing actions performed in response to outputs of business logic may be propagated automatically from one or more entities to one or more other entities based on entity relationships (e.g., relationships between nodes of a hierarchical graph defining a topology of a space, as well as devices/sensors and/or users within the space).

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore considered to be limiting of its scope, the invention will be described and explained with additional specificity and detail through the use of the accompanying drawings in which:

FIG. 1 illustrates an example computer architecture that facilitates operation of the principles described herein.

FIG. 2 illustrates an example environment for providing access to sensor data from devices within a physical space.

FIG. 3 illustrates an example hierarchical graph associated with a physical space.

FIG. 4 illustrates an example an example hierarchical graph associated with a physical space and devices associated with areas or sub-areas of the physical space.

FIG. 5 illustrates a flowchart of a method for providing access to sensor data from devices within a physical space.

FIG. 6 illustrates an example environment for executing business logic for an entity of a relational structure having a plurality of entities.

FIG. 7 illustrates a flowchart of a method for executing business logic for an entity of a relational structure having a plurality of entities.

### DETAILED DESCRIPTION

In the realm of Internet of Things (IoT) devices, there are unique challenges associated with managing the devices, including challenges in managing a representation of the devices as they relate to their physical environment, challenges with handling the vast amounts of data generated by the devices, and challenges with managing user access to the devices and user access rights for associating devices with spaces. For instance, a large organization may own several campuses in different geographical locations. Each of these campuses could be made of a large number of buildings, each of which could have many floors. Each of these floors, in turn could have a large number of physical spaces (e.g., conference rooms, offices, common areas, laboratories, etc.). Each of these physical spaces could include a number of objects, such as desks, chairs, lab equipment, etc. Each of these physical spaces and/or objects in the physical spaces could be associated with a number of IoT devices, each of which could include a number of sensors or other data-generating hardware. Prior approaches have failed to efficiently represent these physical spaces and IoT devices, while providing efficient access to the data generated by the IoT devices. Additionally, prior approaches have failed to provide efficient mechanisms for managing user access as it relates to devices (e.g., user access rights for accessing sensor data and/or user access rights for managing the devices themselves), and/or for managing user access as it relates to physical spaces (e.g., for managing the layout of spaces including their sub-spaces, for managing adding/removing/managing devices in spaces, etc.). For instance, for a large organization, placing all of this data in a single hierarchical graph could result in a graph that is very large both in terms of depth and breadth—and which would require expensive graph traversal operations every time sensor data needs to be updated or accessed.

In view of this recognition, the inventors have invented a multi-database environment for storing such data. In particular, the multi-database environment can include one or more first data structures (e.g., one or more graphs) that store relatively static information in the form of a topology of the physical environment in which the IoT devices exist, including storing references to the devices themselves. The first data structure(s) are configured to facilitate queries that can quickly identify physical spaces, users, and/or IoT device(s) within physical spaces—regardless of the size of the topology; quick queries could mean a tradeoff that operations updating the first data structure(s) is comparatively expensive. The multi-database environment can also include one or more second data structures that store relatively dynamic information, such as sensor data generated by the IoT devices. The second data structure(s) are configured to efficiently store constantly changing data, and to provide quick access to data generated by an IoT device once that device has been identified using the first data structure(s). Users may be managed within the first data structure(s) (e.g., as user nodes associated with device nodes and/or with nodes relating to physical spaces) and/or within the second data structure(s).

At least some embodiments described herein also relate to methods, systems, and computer program products for executing business logic for an entity of a relational structure having a plurality of entities. Embodiments may include obtaining data associated with a first entity of the plurality of entities of the relational structure. The obtained data may at least partially cause actuation of a trigger. Embodiments may further include, based on actuation of the trigger, identifying particular business logic associated with the trigger. Embodiments may further include executing the business logic for a second entity that is related to the first entity within the relational structure, by using the obtained data associated with the first entity as a parameter value for execution of the business logic for the second entity, and performing a computing action based on a result of executing the business logic for the second entity.

Accordingly, an environment for executing business logic for one or more entities may allow for efficiently processing and effectively utilizing data associated with one or more devices related to a space (e.g., physical space or virtual space). Moreover, the environment may allow for chaining one or more triggers, items of business logic, and/or actions, such that complex processing of such data can be utilized. In addition, business logic, and/or computing actions performed in response to outputs of business logic may be propagated automatically from one or more entities to one or more other entities based on entity relationships (e.g., relationships between nodes of a hierarchical graph defining a topology of a space, as well as devices/sensors and/or users within the space).

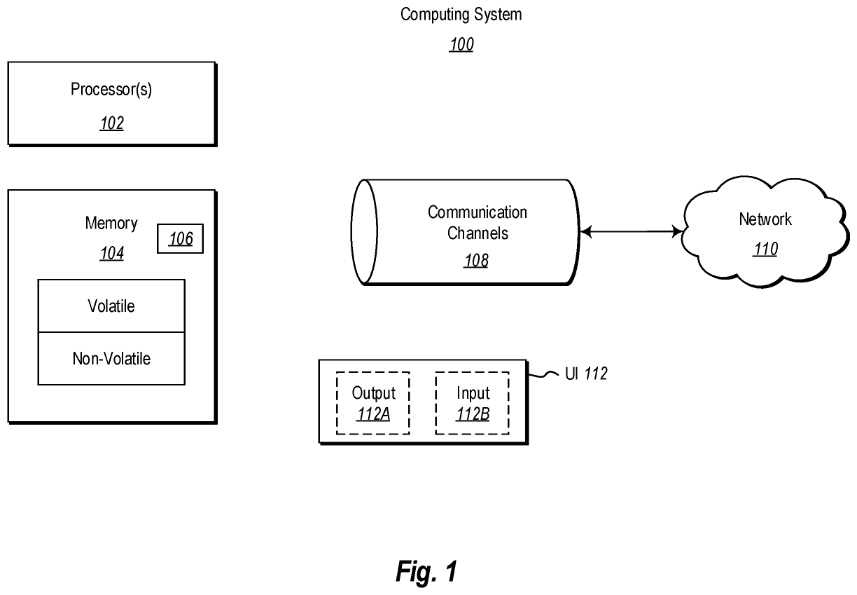

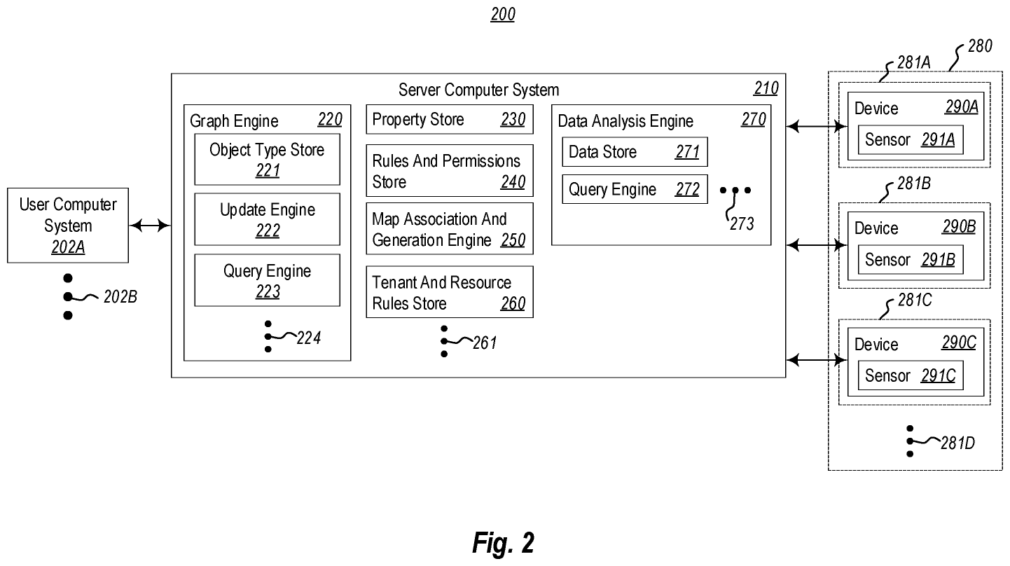

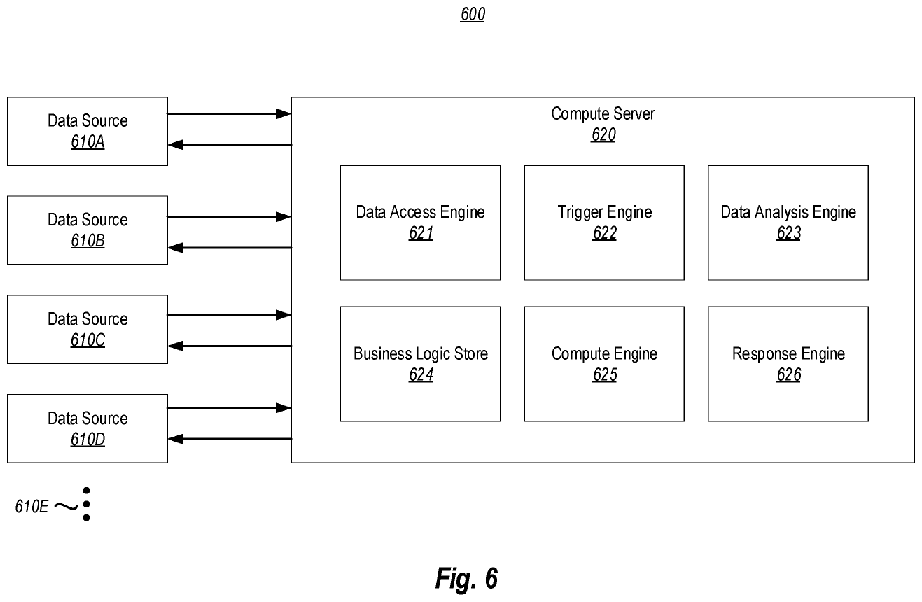

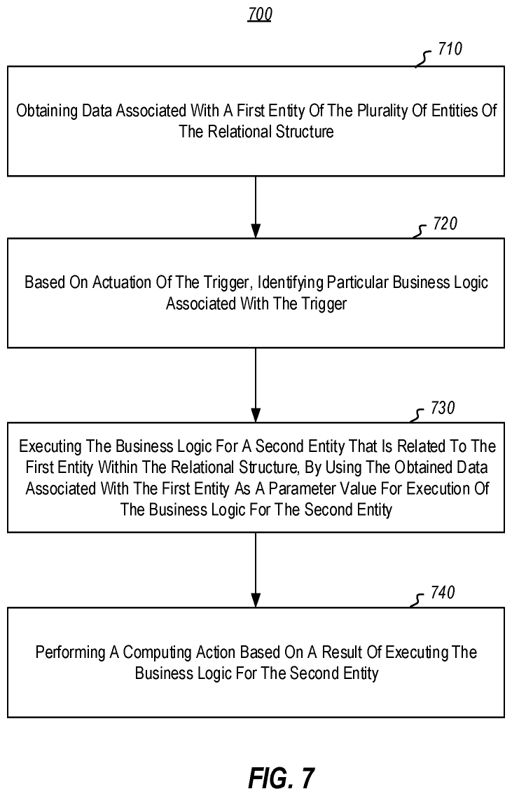

Some introductory discussion of a computing system will be described with respect to FIG. 1. Then, providing access to sensor data from devices within a physical space, consistent with the multi-database environment introduced above, will be described with respect to FIGS. 2 through 5, and executing business logic for an entity of a relational structure having a plurality of entities will be described with respect to FIGS. 6 and 7.

Computing systems are now increasingly taking a wide variety of forms. Computing systems may, for example, be handheld devices, appliances, laptop computers, desktop computers, mainframes, distributed computing systems, datacenters, or even devices that have not conventionally been considered a computing system, such as wearables (e.g., glasses). In this description and in the claims, the term “computing system” is defined broadly as including any device or system (or combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one hardware processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

The computing system 100 also has thereon multiple structures often referred to as an “executable component”. For instance, the memory 104 of the computing system 100 is illustrated as including executable component 106. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed on the computing system, whether such an executable component exists in the heap of a computing system, or whether the executable component exists on computer-readable storage media.

In such a case, one of ordinary skill in the art will recognize that the structure of the executable component exists on a computer-readable medium such that, when interpreted by one or more processors of a computing system (e.g., by a processor thread), the computing system is caused to perform a function. Such structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “service”, “engine”, “module”, “control”, or the like may also be used. As used in this description and in the case, these terms (whether expressed with or without a modifying clause) are also intended to be synonymous with the term “executable component”, and thus also have a structure that is well understood by those of ordinary skill in the art of computing.

In the description that follows, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied on one or more computer-readable media that form a computer program product. An example of such an operation involves the manipulation of data.

The computer-executable instructions (and the manipulated data) may be stored in the memory 104 of the computing system 100. Computing system 100 may also contain communication channels 108 that allow the computing system 100 to communicate with other computing systems over, for example, network 110.

While not all computing systems require a user interface, in some embodiments, the computing system 100 includes a user interface 112 for use in interfacing with a user. The user interface 112 may include output mechanisms 112A as well as input mechanisms 112B. The principles described herein are not limited to the precise output mechanisms 112A or input mechanisms 112B as such will depend on the nature of the device. However, output mechanisms 112A might include, for instance, speakers, displays, tactile output, holograms and so forth. Examples of input mechanisms 112B might include, for instance, microphones, touchscreens, holograms, cameras, keyboards, mouse of other pointer input, sensors of any type, and so forth.

Embodiments described herein may comprise or utilize a special purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computing system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes NAND flash memory or other flash memory, RAM, DRAM, SRAM, ROM, EEPROM, CD-ROM or other optical disk storage, solid-state disk storage, magnetic disk storage or other storage devices, or any other physical and tangible storage medium which can be used to store desired program code means in the form of computer-executable instructions or data structures and which can be accessed by a general purpose or special purpose computing system.

A “network” is defined as one or more data links that enable the transport of electronic data between computing systems and/or modules and/or other electronic devices. When information is transferred or provided over a network or another communications connection (either hardwired, wireless, or a combination of hardwired or wireless) to a computing system, the computing system properly views the connection as a transmission medium. Transmissions media can include a network and/or data links which can be used to carry desired program code means in the form of computer-executable instructions or data structures and which can be accessed by a general purpose or special purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RAM and/or to less volatile storage media at a computing system. Thus, it should be understood that storage media can be included in computing system components that also (or even primarily) utilize transmission media.

Computer-executable instructions comprise, for example, instructions and data which, when executed at a processor, cause a general purpose computing system, special purpose computing system, or special purpose processing device to perform a certain function or group of functions. Alternatively, or in addition, the computer-executable instructions may configure the computing system to perform a certain function or group of functions. The computer executable instructions may be, for example, binaries or even instructions that undergo some translation (such as compilation or interpretation) before direct execution by the processors, such as intermediate format instructions such as assembly language, or even source code.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables (such as glasses) and the like. The invention may also be practiced in distributed system environments where local and remote computing systems, which are linked (either by hardwired data links, wireless data links, or by a combination of hardwired and wireless data links) through a network, both perform tasks. In a distributed system environment, program modules may be located in both local and remote memory storage devices.

Those skilled in the art will also appreciate that the invention may be practiced in a cloud computing environment, which may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

Reference is made frequently herein to Internet of Things (IoT) devices. As used herein, an IoT device can include any device that is connected to a network (whether that be a personal area network, local area network, wide area network, mesh network, and/or the Internet) and that interacts with a physical environment (whether that be to control or influence some aspect of a physical environment, and/or to receive sensor data from a physical environment). As such, references to IoT devices herein should be interpreted broadly to include vast categories of devices, regardless of how those devices may be named or marketed. From a computing perspective, IoT devices may range from fairly complex (e.g., such as being embodied on a general-purpose computer system), to fairly simple (e.g., such as being embodied within a special-purpose microcontroller environment).

FIG. 2 illustrates an example environment 200 for providing access to sensor data from devices within a physical space. As illustrated, the environment 200 includes a user computer system 202A. The user computer system 202A may be embodied, for example, by computer system 100, as described with respect to FIG. 1. The user computer system 202A may comprise any type of computer system that is configured to communicate with, and utilize the functionality of, a server computer system 210, which is described later. In an example, the user computer system 202A may comprise a desktop computer, a laptop computer, a tablet, a smartphone, and so forth. Notably, while the environment 200 includes a single user computer system 202A, the ellipses 202B represents that any number of user computer systems may communicate with, and utilize the functionality of, the server computer system 210.

The server computer system 210 is configured to receive, store, and provide access to sensor data from devices (such as IoT devices) located within physical spaces (e.g., a room within a building), as further described herein. Again, the server computer system 210 may be embodied, for example, by computer system 100, as described with respect to FIG. 1. The server computer system 210 may comprise any type of computer system, including any combination of hardware and/or software that is configured to provide access to sensor data from devices located within particular physical spaces.

As shown, the server computer system 210 may include various engines, functional blocks, and components, including (as examples) a graph engine 220, a property store 230, a rules and permissions store 240, a map association and generation engine 250, a tenant and resource rules store 260, and a data analysis engine 270, each of which may also include additional engines, functional blocks, and components (e.g., an object type store 221 within the graph engine 220). The various engines, components, and/or functional blocks of the server computer system 210 may be implemented on a single computer system, or may be implemented as a distributed computer system that includes elements resident in a cloud environment, and/or that implement aspects of cloud computing (i.e., at least one of the various illustrated engines may be implemented locally, while at least one other engine may be implemented remotely). In addition, the various engines, functional blocks, and/or components of the server computer system 210 may be implemented as software, hardware, or a combination of software and hardware.

Notably, the configuration of the server computer system 210 illustrated in FIG. 2 is shown only for exemplary purposes. As such, the server computer system 210 may include more or less than the engines, functional blocks, and/or components illustrated in FIG. 2. In particular, the ellipses 261 represent that any number of engines, functional blocks, and/or components may be utilized within the server computer system. Although not illustrated, the various engines of the server computer system 210 may access and/or utilize a processor and memory, such as the processor 102 and the memory 104 of FIG. 1, as needed, to perform their various functions.

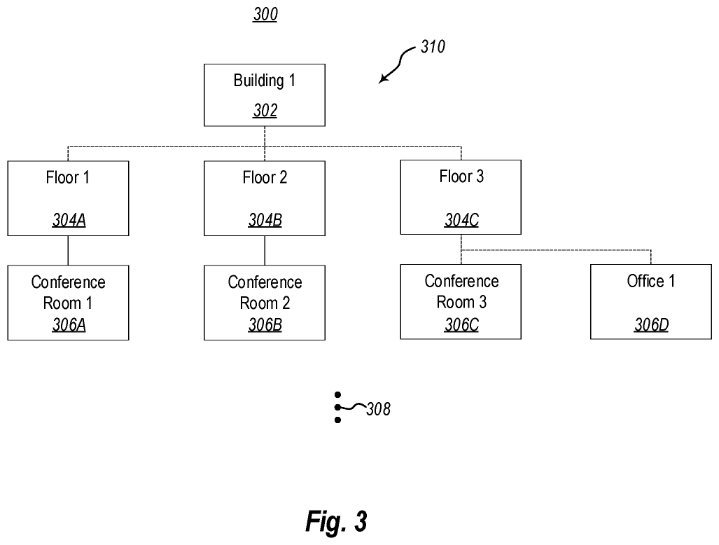

As briefly introduced, the server computer system 210 includes the graph engine 220, the property store 230, the rules and permissions store 240, the map association and generation engine 250, the tenant and resource rules store 260, and the data analysis engine 270. The graph engine 220 may be configured to generate, store, and/or manage one or more hierarchical graphs (e.g., hierarchical graph 310 of FIG. 3) that defines a topology of areas and sub-areas of a physical space. For instance, FIG. 3 illustrates a hierarchical graph 310 that includes a topology of nodes associated with a physical space comprising “building 1” (e.g., building node 302). The hierarchical graph 310 also represents areas and sub-areas of “building 1,” such as different floors (i.e., floor node 304A, floor node 304B, and floor node 304C, all of which are sub-nodes of building node 302), as well as different rooms (i.e., conference room node 306A, conference room node 306B, conference room node 306C, and office node 306D) associated with each floor. Although not shown, each of the room nodes 306A-306A could be associated with additional sub-nodes representing physical objects in the rooms, such as desks, chairs, tales, computer, lab equipment, etc.

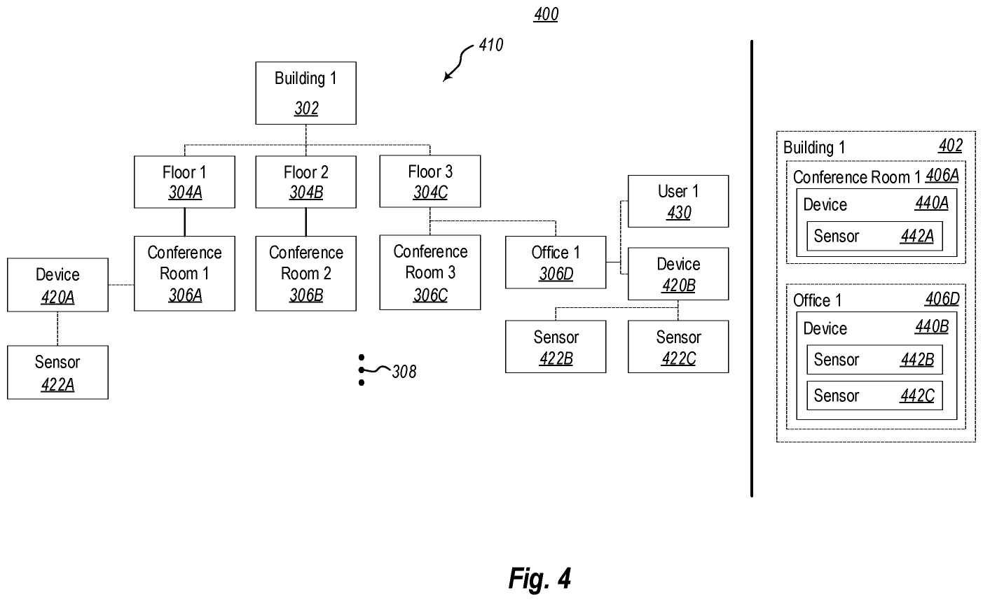

Any node in the hierarchical graph 310 could be associated with devices/sensors and/or users. For example, the various room nodes (i.e., the conference room node 306A and the office node 306D) may also be associated with devices and sensors, and the room nodes and/or the device/sensor nodes may be associated with user nodes. Similarly, FIG. 4 shows a related graph 410, that includes device nodes 420A and 420B and sensor nodes 422A-422C. While only seven nodes associated with areas/sub-areas are illustrated in FIG. 3, the ellipses 308 represents that any number of nodes that are associated with areas/sub-areas and devices/sensors may be utilized when practicing the principles described herein (whether those nodes be added or deleted in a horizontal direction (breadth) or a vertical direction (depth)). Furthermore, the topology of the graph may be continuously modified via adding or deleting nodes of the graph (in a horizontal direction or vertical direction). For instance, using the example of FIG. 3, a number of additional building nodes associated with different buildings than building 1 (corresponding to building node 302), each of which additional buildings may include additional nodes corresponding to floors, rooms, and so forth, may also be included within the graph 310.

In some embodiments, the hierarchical graph 310 may be stored within a relational database, though any type of database could be used. Additionally, regardless of the type of graph used, the full paths in the graph for each given node may be stored as metadata in the node to increase the performance and efficiency of querying the hierarchical graph 310. In this way, identification (e.g., via a query) of any ancestral node or child node (i.e., children nodes, grandchildren nodes, great-grandchildren nodes, and so on) of a given node may be performed in an order of one operation (i.e., an O(1) operation). For instance, a query that requests each node having a path that starts with “building 1/floor3” (i.e., corresponding to the floor node 304C) may identify conference room 3 and office 1 (i.e., corresponding to conference room node 306C and office node 306D, respectively) as being children of the floor node 304C in an O(1) operation.

Notably, even if the conference room node 306C and the office node 306D were grandchildren, great-grandchildren, and so on, of the floor node 304C, a request for identification of each node having a path that starts with “building 1/floor3” could result in identification of the conference room node 306C and the office node 306D (as well as any nodes between the floor node 304C and the conference room node 306C/the office node 306D) in an O(1) operation. Accordingly, paths associated with each node may be automatically computed and saved, which effectively tracks a primary identification for each node of the graph. While a cost is incurred upfront to generate and store each path (e.g., in connection with the addition and/or removal of one or more nodes to within the graph), the graph may be quickly and efficiently traversed to identify nodes and relationships between nodes within the graph than traditional traversing of graphs. By storing primarily static information in the graph, however, the need to generate/store these paths can be relatively infrequent.

Returning to FIG. 2, as illustrated, the graph engine 220 includes various components that may comprise any combination of appropriate hardware and/or software, including an object type store 221, an update engine 222, and a query engine 223. Notably, the ellipses 224 represents that any number of components may be included with the graph engine 220 (i.e., more or less than the components illustrated within the graph engine 220).

The object type store 221 comprises a data store of node object types that can be selected to create additional nodes within the graph 310. For instance, in addition to the node object types of buildings, floors, and rooms that are explicitly shown in FIG. 3, any number of object types associated with areas/sub-areas of physical spaces (as well as devices/sensors and users/individuals, as further described herein) may be used within the graph 310, including but not limited to organizations (e.g., businesses), geographic regions (e.g., continents, countries, states, cities, counties, and so forth), types of areas (e.g., buildings, farms, houses, apartments, conference rooms, offices, bathrooms, breakrooms, study areas, desks, chairs, and so forth), types of devices (e.g., thermostat, projector, paper towel dispenser, television, computer, and so forth), types of sensors (e.g., thermocouple, thermistor, humidity sensor, CO₂ sensor, Geiger counter), and so forth. Additionally, the object type store 221 may be extensible, such that additional object types may be created on demand.

The update engine 222 may be configured to update the hierarchical graph 310 with any changes made to the graph. For instance, the update engine 222 may update the graph with additional nodes, update the graph with less nodes (e.g., deleted nodes), update nodes with new or modified properties, update nodes with new or modified paths, and perform any other operations associated with modifying or updating the graph.

The query engine 223 may be configured to allow for performing queries to the hierarchical graph 310. In particular, the query engine 223 may be configured to receive queries, generate query plans, build responses to queries, and/or perform any other operations associated with receiving and responding to queries of the hierarchical graph 310.

As briefly introduced, the server computer system 210 further includes data analysis engine 270. The data analysis engine 270 may be configured to receive, gather, manage, and process data received from devices/sensors located within a physical space (associated with the hierarchical graph that defines the topology of the physical space). For instance, FIG. 2 illustrates various devices and sensors located within a physical space 280. In particular, the physical space 280 comprises various areas and sub-areas, including area/sub-area 281A, area/sub-area 281B, and area/sub-area 281C. Each of the sub-areas includes a single device having a single sensor (i.e., area/sub-area 281A includes device 290A having sensor 291A, area/sub-area 281B includes device 290B having sensor 291B, and area/sub-area 281C includes device 290C having sensor 291C). Notably, while each of the areas/sub-areas within the physical space 280 includes a single device having a single sensor, the ellipses 290 represents that there may be any number of areas/sub-areas within the physical space 280, each of the areas/sub-areas including any number of devices having any number of sensors (including zero devices/sensors).

Notably, the devices and sensors may include any type of devices/sensors, including but not limited to devices/sensors associated with detecting temperature, CO₂, light, pressure, toxic chemicals, humidity, and so forth. As such, the combination of the devices 290 (i.e., the device 290A through the device 290C) and the sensors 291 (i.e., the sensor 291A through the sensor 291C) may be configured to capture sensor data (e.g., changes in temperature) and send the captured data to the data analysis engine 270. The sensors may provide data to the data analysis engine 270 periodically and/or continuously. Thus, in some implementations, sensors the data analysis engine 270 may receive, gather, manage, and process real-time or near real-time data received from the sensors. The sensors may actively push data to the data analysis engine 270, or may only provide it upon request.

The data analysis engine 270 may then be configured to receive, gather, manage, and process data received from such devices/sensors. In particular, as illustrated, the data analysis engine 270 may include a data store 271 that is configured to organize, store, and allow access to received sensor data. The data store 271 may comprise any type of data store that is configured to manage dynamic, frequently changing data such as sensor data, and that provides quick and efficient performance. In an example, the data store 271 may comprise a key-value database. For instance, the data store 271 may comprise a distributed, in-memory key-value store. The data store 271 may store some data permanently, while only storing other data temporarily. For example, when receiving real-time or near real-time data, the data analysis engine 270 may processes large quantities of data, making it infeasible and/or undesirable to store it permanently. Data associated with a particular device (e.g., sensor data) may also be linked with device nodes of the hierarchical graph (e.g., the hierarchical graph 410), such that upon identification of a device node within the hierarchical graph, sensor data associated with the device corresponding to the device node may also be accessed, as further described herein.

As shown, the data analysis engine 270 further includes a query engine 272. The query engine 272 may be configured to allow for performing queries to the data store 271. In particular, the query engine 272 may be configured to receive queries, generate query plans, build responses to queries, and/or perform any other operations associated with receiving and responding to queries of the data store 271.

FIG. 4 illustrates an environment 400 including hierarchical graph 410 comprising area/sub-area nodes, as well as device/sensor nodes that are each associated with one or more area/sub-area nodes. As shown, the conference room node 306A is associated with device node 420A (having a corresponding sensor node 422A) and the office node 306D is associated with the device node 420B (having two corresponding sensor nodes, the sensor node 422B and the sensor node 422C). Additionally, FIG. 4 includes a representation of an actual physical space 402 (associated with building 1) that corresponds to the building node 302.

As illustrated, the physical space 402 also comprises conference room 406A (associated with conference room 1 and corresponding to the conference room node 306A) that includes the actual physical device 440A having the sensor 442A, as well as office 406D (associated with office 1 and corresponding to the office node 306D) that includes the actual physical device 440B having both the sensor 442B and the sensor 442C. In a specific example, the device 440A may correspond to a thermostat that includes a thermocouple (i.e., the sensor 442A) for measuring temperature. Such temperature measurements may then be sent to the data analysis engine for managing, storing, and processing the received sensor data.

Additionally, as illustrated in FIG. 4, user nodes (e.g., user node 430) may be included within the hierarchical graph 410 as being associated with one or more area/sub-area nodes (though they could additionally, or alternatively, be associated with sensor/device nodes). In particular, FIG. 4 shows the user node 430 being associated with the office node 306D. In a specific example, the user 1 (i.e., corresponding to the user node 330) may comprise an individual that has been assigned to office 1 (i.e., corresponding to the office node 306D). In this example, user node 430 could be used to control a user's access to office node 306D, including, for example, the user's ability to modify office node 306D, to attached nodes to office node 306D, remove nodes from office node 306D, or modify nodes that are already attached to office node 306D, etc. In some embodiment, associating user node 430 with office node 306D applies the user node's permissions to all nodes hierarchically below office node 306D in hierarchical graph 410. Similar application of access rights could apply when associating a user node with a sensor/device node.

Notably, regardless of object/node type (e.g., area/sub-area nodes, device nodes, sensor nodes, user nodes), data and/or metadata associated with the node may be stored in the hierarchical graph (e.g., the hierarchical graph 310 or the hierarchical graph 410), the data store 271 of the data analysis engine 270, or any other appropriate location associated with the server computer system 210.

As briefly introduced, the server computer system 210 further includes property store 230, rules and permissions store 240, map association and generation engine 250, and tenant and resource store 260. The property store 230 may comprise a data store that includes properties associated with nodes of the hierarchical graph 310. For instance, particular properties may automatically be associated with particular object types (i.e., node types), as well as children of such object types. In a more particular example, a property associated with occupancy of a chair within a room may propagate to the room itself (i.e., showing that the room is occupied) and further, as configured by a propagation policy. Furthermore, as discussed with respect to the object type store 231, the property store may also be extensible, such that properties may be created and associated with any given node, and potentially associated with ancestral or children nodes of the given node.

The rules and permissions store 240 may include various rules and permissions associated with particular roles assigned to users. For instance, based on a particular role (e.g., an administrator) assigned to a user, the user may have access to perform various operations, including adding/deleting nodes, modifying nodes, accessing/modifying functionality of various devices (e.g., locking doors), and so forth. The rules/permissions stored in the rules and permissions store 240 may be applied to various nodes in the hierarchical graph, whether those be area/sub-area nodes, sensor/device nodes, or user nodes. The rules/permissions stored in the rules and permissions store 240 may additionally, or alternatively, be applied data in the data store 271. In some embodiments, user nodes that are associated with nodes in the graph (e.g., areas or devices/sensors) grant corresponding users access to the associated node, and user rules/permissions associated with those user nodes are managed in the rules and permissions store 240.

The map association and generation engine 250 may be configured to perform numerous functions with respect to associating maps with the hierarchical graph (and devices providing data to the data store), and/or generating the hierarchical graph, itself. For instance, the map association and generation engine 250 may be able to generate the hierarchal graph 300 based on user input and/or based on a map. In another example, the map association and generation engine 250 may be able to link nodes of the hierarchical graph to locations or devices included within a map. In yet another example, the map association and generation engine 250 may further be able to generate a map based on information included within the hierarchical graph corresponding to nodes of the hierarchical graph.

The tenant and resource rules store 260 may include rules associated with how resources, permissions, properties, and so forth are to be handled for each given entity (e.g., tenant) that utilizes the hierarchical graph.

Notably, the ellipses 261 represent that the server computer system 210 may include any number of components (i.e., whether more or less) than the components illustrated within the server computer system in FIG. 2. For instance, while both the graph engine 220 and the data analysis engine 270 include corresponding query engines (i.e., the query engine 223 and the query engine 272, respectively), an overarching query engine may be included within the physical analytics computer system that allows for querying both the graph engine 220 and the data analysis engine 270. In this way, a user may be able to generate queries that can traverse the hierarchical graph (e.g., the hierarchical graph 410) to identify one or more devices associated with a particular area/sub-area of the hierarchical graph, as well as current (or previous) sensor data associated with the one or more devices via the data store 271 and the data analysis engine 270.

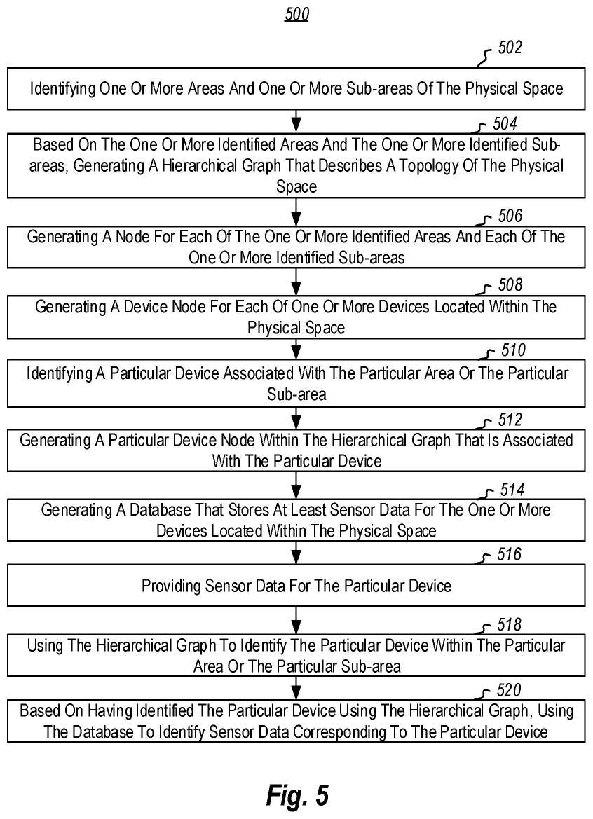

FIG. 5 illustrates a flowchart of a method 500 for providing access to sensor data from devices within a physical space. The method 500 is described with frequent reference to the environments of FIGS. 2-4. As shown, the method 500 includes identifying one or more areas and one or more sub-areas of the physical space (Act 502). For instance, the building 402, the conference room 406A, and/or the office 406D of FIG. 4 may be identified by the map association and generation engine 250. The method 500 further includes, based on the one or more identified areas and the one or more identified sub-areas, generating a hierarchical graph that describes a topology of the physical space (Act 504). For instance, based on the identification of the building 402 (and its corresponding areas/sub-areas), the hierarchical graph 410 may be generated by the map association and generation engine 250.

Generating the hierarchical graph further includes generating a node for each of the one or more identified areas and each of the one or more identified sub-areas (Act 506). For example, the hierarchical graph 410 includes various nodes based on an identification of areas/sub-areas associated with the building 402. Generating the hierarchical graph also includes generating a device node for each of one or more devices located within the physical space (Act 508). For instance, an identification of the device 440A and the device 440B may result in generating the device node 420A and the device node 420B, respectively.

Generating the device node for each of one or more devices located within the physical space further includes, for a particular one of the one or more areas or the one or more sub-areas, identifying a particular device associated with the particular area or the particular sub-area (Act 510). The particular device may include one or more sensors that generate data. For example, the device 440A may be identified, as well as the sensor 442A.

Generating the device node for each of one or more devices located within the physical space further includes, for a particular one of the one or more areas or the one or more sub-areas, generating a particular device node within the hierarchical graph that is associated with the particular device (Act 512). The particular device node may be a sub-node of a particular node that was generated for the particular area or the particular sub-area. For instance, the device node 420A may be generated in response to identifying the device 440A, and may further be associated with a particular area/sub-area node (i.e., the device node 420A being associated with the conference room node 306A). Additionally, any sensors associated with the device 440A may be identified, including the sensor 422A.

The method 500 further includes generating a database that stores at least sensor data for the one or more devices located within the physical space (Act 514). The database may be associated with, but separate from, the hierarchical graph. For example, the data store 271 may be generated for managing, storing, and accessing received sensor data. The method 500 may further include providing sensor data for the particular device (Act 516). For example, data from the sensor 442A of device 440A may be provided to the data store 271. In a more specific example, the sensor 442A may be configured to measure CO₂ levels, which measurements may be provided by the device 440A (or by another device capable of communicating with the device 440A) to the data store 271 (and ultimately, the data analysis engine 270).

Providing sensor data for the particular device may also include using the hierarchical graph to identify the particular device within the particular area or the particular sub-area (Act 518). For example, a query provided to the server computer system 210 (and perhaps directly to the graph engine 220) may request an identification of each device (and therefore each device node) associated with a particular area/sub-area (and therefore the particular area/sub-area node corresponding to the particular area/sub-area). Providing sensor data for the particular device may further include, based on having identified the particular device using the hierarchical graph, using the database to identify sensor data corresponding to the particular device (Act 520). For instance, upon identifying the device/device nodes (and the corresponding sensors/sensor nodes), sensor data associated with the devices/sensors may then be identified within the data store 271.

Accordingly, the principles described herein may allow for logically organizing devices (e.g., Internet of Things (IoT) devices) and/or users based on physical spaces (or areas/sub-areas of physical spaces), thus allowing for both intuitive organization, access, and control of a plurality of devices, as well as efficient use of such devices. For instance, each device associated with a particular area/sub-area (e.g., on a particular floor of a building or a particular room) may be easily shut off or placed in a reduced power state, as location-based groupings of devices are automatically created. In particular, relatively static physical space data (e.g., data regarding floors and rooms of a building) may be placed in a reliable graph (e.g., a relational database), while more dynamic sensor data may be managed in a more dynamic database (e.g., a distributed, in-memory key-value store).

The reliability of a hierarchical graph may be supplemented with quickness/efficiency by computing and storing paths associated with each node upfront when adding/removing/modifying nodes in the graph. Computing and storing the paths may then allow for performing queries with respect to ancestral nodes or child nodes of any given node in an O(1) operation. The hierarchical graph and the dynamic database may then be linked such that sensor data stored at the dynamic database may be quickly accessed when querying nodes associated with an area/sub-area within the hierarchical graph. Accordingly, storing the hierarchical graph and the dynamic database within an improved computer system (e.g., within memory and/or persistent storage) may improve the speed and efficiency of the computer system with respect to traversing the hierarchical graph in response to queries, building responses to queries (e.g., surfacing live sensor data associated with a particular area or sub-area of a physical space corresponding to the hierarchical graph), and so forth.

FIG. 6 illustrates an environment 600 for processing data at a computer server 620 that is received from one or more data sources 610 (i.e., data source 610A through data source 610D). Such processing may then result in one or more outputs and/or actions, as further described herein. Notably, in some embodiments, the environment 600 may be used particularly with respect to hierarchical graphs that define topologies of spaces (e.g., physical spaces and/or virtual spaces) that have a number of IoT devices, as described with respect to FIGS. 2 through 5. In particular, the environment 600 may allow for defining business logic for data (e.g., data streams) generated/detected by devices/sensors associated with IoT devices associated with such spaces.

While only four data sources 610 are illustrated in FIG. 6, the ellipses 610E represents that any number of data sources may be utilized when practicing the principles described herein. The data sources 610 may provide telemetry data, properties from a graph, or any other applicable type of data that can be utilized by the compute server, as further described herein. In an example, one or more of the data sources 610 may comprise a device and/or sensor that generates data (e.g., a thermocouple detecting a temperature)

In some embodiments, the data sources may be associated with nodes of a hierarchical graph (e.g., the hierarchical graph 310, the hierarchical graph 410, and so forth). For instance, at least one of the data sources 610 may comprise a device/sensor located within an area/sub-area of a physical space for which a hierarchical graph (i.e., topological graph) has been created. In a more specific example, the sensor 422A of the device 420A, the sensor 422B of the device 420B, and the sensor 422C of device 420B of FIG. 4 may each comprises a data source 610. Alternatively, or additionally, one or more of the data sources 610 may comprise external data sources that are external to such devices/sensors of an area/sub-area of physical space having a hierarchical graph. For instance, weather data from a weather service may comprise a data source 610. Such external data sources may also be associated with a particular node (e.g., an area of a physical space).

As illustrated, FIG. 6 also includes a compute server 622 that is configured to receive data from the data sources 610, perform analyses on the received data, and in response to the analyses, perform one or more actions. As shown, the computer server includes a data access engine 621, a trigger engine 622, a data analysis engine 623, a business logic store 624, a compute engine 625, and a response engine 626. Each of these components (i.e., the data access engine 621, the trigger engine 622, the data analysis engine 623, the business logic store 624, the compute engine 625, and the response engine 626) may comprise any combination of applicable hardware and/or software, and may utilize any combination of local and/or cloud computing resources. Additionally, in some embodiments, two or more of these components may be combined into a single component. Alternatively, any of the components may be split into additional components.

The data access engine 621 may be responsible for receiving and/or gathering data from the data sources 610. For instance, the data access engine may subscribe to events of the one or more of the data sources 610 (e.g., within an event-based publisher/subscriber model) in order to access data produced by the one or more data sources. The data access engine 621 may then provide access to such data to the trigger engine 622. Notably, in some embodiments, the data access engine 621 and the trigger engine 622 may comprise a single component.

The trigger engine 622 may include a plurality of triggers associated with data provided by the data sources 610. Each trigger may then cause the data analysis engine 623 to identify appropriate business logic from the business logic store 624 to be executed based on a given trigger, as further described herein. In an example, triggers may include temporal triggers (e.g., triggers that occur based on expiration of a given period of time). In another example, a trigger may occur each time data associated with a given data source changes, each time a given data source provides data to the compute server 620, and so forth. In yet another example, a trigger may occur when a change has occurred within a hierarchical graph (e.g., the hierarchical graph 310, the hierarchical graph 410, and so forth). For instance, when a parameter value associated with a node in the hierarchical graph has changed or a new node has been added to the hierarchical graph, a trigger may occur. In still another example, a trigger may occur based on an action being taken by the response engine 626, as further described herein.

While numerous examples and types of triggers are discussed, essentially an unlimited number of triggers may be used and understood by one of skill in the art to practice the principles described herein. As such, triggers associated with the trigger engine 622 may be extensible, such that a user (e.g., an administrator) may create additional triggers that cause the data analysis engine to identify business logic to be executed in association with the additional triggers. Accordingly, upon occurrence of a trigger, the trigger engine may alert the data analysis engine 623.

The data analysis engine 623 may be configured to, in response to a trigger, identify particular business logic from the business logic store 624 to be executed by the compute engine 625, as further described herein. Accordingly, the business logic store 624 may include a plurality of business logic that is to be executed in response to identification by the data analysis engine of one or more triggers. Upon identification of the occurrence of a particular trigger, the data analysis engine 623 may analyze a number of factors to determine particular business logic to be executed.

For instance, the data analysis engine may analyze any combination of the particular trigger occurring, the particular data source 610 associated with the particular trigger, a type of data (i.e., data from the particular data source) associated with the particular trigger, one or more properties of the data, a relationship of the data (i.e., data from the particular data source that at least partially caused the trigger) to one or more nodes of a hierarchical graph, a relationship between nodes of the hierarchical graph that are associated with the trigger, and so forth to determine the particular business logic to be executed by the compute engine 625. In a particular example associated with the relationship of the data to one or more nodes of the hierarchical graph, the data analysis engine may determine that particular business logic is to be used based on a location of the data source (e.g., a device/sensor located within an area of a physical space for which a hierarchical graph has been generated) within a physical space.

Notably, when relationships of nodes of a hierarchical graph that are associated with a particular trigger is a consideration of the data analysis engine, the data analysis engine may determine that different business logic is to be executed with respect to different related nodes and/or that the same business logic is to be executed with respect to multiple nodes. In an example, when the data analysis engine determines that a particular trigger is associated with a particular node of a hierarchical graph, the data analysis engine may also determine each relationship that the particular node has with other nodes in the hierarchical graph. In a more specific example, the data analysis engine may determine that a particular node associated with a trigger has one or more child nodes, and thus may determine that particular item(s) of business logic are to be executed with respect to the particular node and each child node of the particular node.

Accordingly, the data analysis engine may identify multiple items of business logic that are to be executed in response to one or more triggers or may identify particular business logic that is to be executed multiple times (e.g., with respect to different nodes of a hierarchical graph). In such cases, the data analysis engine may determine a priority of execution of each item of business logic to be executed, whether multiple items of different business logic are to be executed or the same particular business logic is to be executed multiple times. Moreover, the data analysis engine (or any other applicable component) may determine priorities associated with nodes of a hierarchical graph, items of business logic, actions (as further described herein), and so forth. For instance, priorities may be pre-defined based on what a user determines is most important, may be based on availability of resources, may be based on estimated impact to resources, and so forth.

As briefly described, the compute engine 625 may be configured to execute business logic (e.g., business logic stored with the business logic store 624) identified by the data analysis engine 623. Accordingly, the compute engine 625 may communicate with the data analysis engine 623 and/or the business logic store 624 to determine any items of business logic that are to be executed by the compute engine. Notably, the business logic store 624 may be extensible, such that users can create additional business logic to be executed in response to one or more triggers. The compute engine may then be configured to execute such additional business logic.

In some embodiments, business logic may be associated with one or more particular nodes of a hierarchical graph (e.g., the hierarchical graph 410). For instance, particular business logic may be associated with a particular node in the hierarchical graph. Furthermore, in response to associating the particular business logic with the particular node, the particular business logic may also be propagated to (e.g., associated with) other nodes that are related to the particular node. For instance, assume the particular node is a parent node. In such a case, the particular business logic may also be propagated to each child node of the parent node. In another example, the particular business logic may be propagated to one or more sibling nodes of the particular node or to a parent node of the particular node. Alternatively, business logic may be associated with a particular region of a hierarchical graph.

As briefly described, the compute engine is configured to execute business logic identified by the data analysis engine in response to a trigger. In an example, the compute engine may execute business logic associated with determining whether a room (e.g., a room having an associated node within a hierarchical graph) is occupied based on one or more motion sensors located within the room. In another example, the compute engine may execute business logic related to determining an average temperature of a room over a particular period of time (e.g., 30 minutes). When executing such business logic, the compute engine may produce an output. For instance, using the example of calculating an average temperature, assume that the business logic also includes a determination of whether the average temperature is above or below a certain threshold (e.g., above 74 degrees, below 65 degrees, and so forth). In such an example, an output of the execution may include a yes/no determination of the temperature being above or below the threshold and/or the calculated average temperature. Again, while particular examples are described herein, virtually unlimited types of business logic and outputs associated with such business logic may be used by practicing the principles described herein.

Regardless of the type of output, the output may be provided to the response engine 626. The output engine 626 may be configured to perform one or more actions in response to outputs of the compute engine 625. For instance, the response engine 626 may be configured to send a communication (e.g., an email, a text message, a push notification, and so forth) to a user (e.g., administrator). In more specific examples, such a communication may be to inform the user of the particular output, of a current state (e.g., a broken sensor within a room, an overheated room, and so forth), of an action that should be taken (e.g., sending a technician), and so forth. In other examples,

In other examples, the response engine may store a calculated value associated with a property of a node of a hierarchical graph, may cache an output for efficient later retrieval, modify a property of a node, alert a technician, alert a fire department or police department, modify data associated with a node of a hierarchical graph, generate a new node associated with a hierarchical graph, modify a hierarchical graph, modify the behavior of a device (e.g., turn down the temperature of a room), call into an application programming interface (API), set off an alarm, and so forth. Yet again, while particular examples of actions are discussed herein, a virtually unlimited number of actions may be taken by the response engine 626 in response to outputs of the compute engine 625. Notably, each action taken may be performed in response to a single calculation. As such, any given calculation (e.g., performed by the compute engine) may result in zero, one, or multiple actions being taken by the response engine.

Moreover, in some embodiments, the response engine may cause a trigger associated with the trigger engine 622 to occur, such that the data analysis engine can identify particular business logic to be executed by the compute engine 625 in response to the trigger (i.e., causing the process to be repeated). Such repeating of the process described further herein may be referred to as chaining. Chaining may thus allow for complex computations and outputs that can repeatedly cause triggers, identify appropriate business logic, execute the business logic, generate an output, and perform an action in response to the generated output.

When using the environment 600 with respect to a relational structure (e.g., the hierarchical graph 410), actions performed, or results of actions performed, with respect to a particular node may also be propagated to other nodes based at least partially on relationships of the other nodes to the particular node. For instance, assume a property value associated with a particular node of a hierarchical graph has been calculated by the response engine 626. The calculated property value may then be propagated to other nodes related to the particular node (e.g., child nodes, sibling nodes, parent nodes, and so forth). In a more specific example, assume that the compute engine 625 and/or the response engine 626 have determined that office 406D of FIG. 4 is occupied (e.g., based on motion sensor data). As such, the office node 306D associated with the office 406D may include a property associated with occupancy that has been modified to indicate that the office is occupied. In addition, the property value indicating current occupancy may then automatically be propagated to the floor node 304C and/or the building node 302 based on the relationship of the office node 306D to the floor node 304C and the office node 302.

In another specific example of propagation, assume that the building node 302 is associated with a particular item of business logic that will result in calling the fire department whenever data associated with one or more of the devices 610 indicates that there is a fire in the building. As such, the particular item of business logic and/or the action of calling the fire department may be propagated to each of the child nodes (e.g., the floor node 304A, the floor node 304B, the conference room node 306A, and so forth) of the building node 302. Accordingly, if data indicating the conference room node 306B is on fire is determined by the compute server 620, the fire department will automatically be called based at least partially on the relationship of the conference room node 306B to the building node 302.

Notably, propagation of triggers, items of business logic, and/or actions taken in response to execution of business logic may be defined at least partially, or solely, by relationship or by a user. For instance, a user may define that particular business logic is to apply to a particular node and each parent of the particular node up to a root node. In another example, a user may define that particular business logic is to apply to a particular node and each sibling, each parent within two levels, and each child within three levels of the particular node. Accordingly, depth levels (i.e., propagation depth or depth limits) in association with any propagation of triggers, business logic, and actions may be defined to particular nodes or particular levels of nodes within a hierarchical graph.

FIG. 7 illustrates a flowchart of a method 700 for executing business logic for an entity of a relational structure having a plurality of entities. The method 700 is described with frequent reference to the environments of FIGS. 2-4 and 6. As shown, the method 700 includes obtaining data associated with a first entity of the plurality of entities of the relational structure (Act 710). The obtained data at least partially causes actuation of a trigger. For instance, data may be obtained from one or more data sources 610 that are related to a node of the hierarchical graph 410. In a more specific example, assume that the data was obtained from sensor 422A, which sensor comprises a temperature sensing device (e.g., a thermocouple). As such, the obtained temperature data may be associated with the conference room 406A, and therefore, the conference room node 306A of the hierarchical graph 410. The method 700 also includes, based on actuation of the trigger, identifying particular business logic associated with the trigger (Act 720). In the continuing example, the trigger may be any applicable trigger associated with data of the sensor 422A. For instance, the act of receiving data associated with the sensor 422A may result in a trigger.

The method 700 further includes executing the business logic for a second entity that is related to the first entity within the relational structure, by using the obtained data associated with the first entity as a parameter value for execution of the business logic for the second entity (Act 730). In the continuing example, the data analysis engine 623 may identify particular business logic to be executed in response to the identified trigger associated with temperature data of the sensor 422A. Upon identifying the particular business logic, the compute engine 625 may execute the particular business logic for the floor node 304A or the building node 302 based on the relationship of the floor node 304A and/or the building node 302 with the conference room node 306A. In a specific example, the business logic may be determining an average temperature over a specific period of time (e.g., 15 minutes) based on temperature data associated with the sensor 422A. Accordingly, in the ongoing example, assume that executing the particular business logic resulted in a determination that the floor 1, and/or the building 402 (as well as the conference room 406A) are on fire. The method 700 further includes performing a computing action based on a result of executing the business logic for the second entity (Act 740). In the ongoing example, the computing action may comprise alerting a building administrator that the building 402 is on fire, alerting an appropriate fire department that the building is on fire, changing one or more property values of the building node 302, the floor node 304A, and the conference room node 306A, and so forth.

Accordingly, an environment for executing business logic for one or more entities may allow for efficiently processing and effectively utilizing data associated with one or more devices related to a space (e.g., physical space or virtual space). Moreover, the environment may allow for chaining one or more triggers, items of business logic, and/or actions, such that complex processing of such data can be utilized. In addition, business logic, and/or computing actions performed in response to outputs of business logic may be propagated automatically from one or more entities to one or more other entities based on entity relationships (e.g., relationships between nodes of a hierarchical graph defining a topology of a space, as well as devices/sensors and/or users within the space).

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A computer system comprising:
one or more processors; and
one or more computer-readable storage media having stored thereon computer-executable instructions that are executable by the one or more processors to cause the computer system to execute business logic for an entity of a relational structure having a plurality of entities, the computer-executable instructions including instructions that are executable to cause the computer system to perform at least the following:
obtain data associated with a first entity of the plurality of entities of the relational structure, the obtained data at least partially causing actuation of a trigger;
based on actuation of the trigger, identify particular business logic associated with the trigger;
execute the business logic for a second entity that is related to the first entity within the relational structure, by using the obtained data associated with the first entity as a parameter value for execution of the business logic for the second entity; and
perform a computing action based on a result of executing the business logic for the second entity.

2. The computer system of claim 1, wherein the computing action comprises execution of new business logic.

3. The computer system of claim 1, wherein the computing action comprises an alert.

4. The computer system of claim 1, wherein the computer-executable instructions further include instructions that are executable to cause the computer system to perform a business logic prioritization, and wherein executing the business logic is performed as a result of the business logic prioritization.

5. The computer system of claim 1, wherein the computer-executable instructions further include instructions that are executable to cause the computer system to perform an entity prioritization, and wherein executing the business logic is performed as a result of the entity prioritization.

6. The computer system of claim 1, wherein the relational structure comprises a hierarchical graph.

7. The computer system of claim 6, wherein the second entity comprises a parent node of the first entity.

8. The computer system of claim 6, wherein the first entity comprises a first node of the hierarchical graph and the business logic is associated with each node of the hierarchical graph that is related to the first node.

9. The computer system of claim 8, wherein the business logic includes a depth limit that defines a distance from the first node at which the business logic applies.

10. A method, implemented at a computer system including one or more processors, for executing business logic for an entity of a relational structure having a plurality of entities, the method comprising:
obtaining data associated with a first entity of the plurality of entities of the relational structure, the obtained data at least partially causing actuation of a trigger;
based on actuation of the trigger, identifying particular business logic associated with the trigger;
executing the business logic for a second entity that is related to the first entity within the relational structure, by using the obtained data associated with the first entity as a parameter value for execution of the business logic for the second entity; and
performing a computing action based on a result of executing the business logic for the second entity.

11. The method of claim 10, wherein the computing action comprises execution of new business logic.

12. The method of claim 10, wherein the computing action comprises an alert.

13. The method of claim 10, further comprising:
performing a business logic prioritization, and wherein executing the business logic is performed as a result of the business logic prioritization.

14. The method of claim 10, further comprising:
performing an entity prioritization, and wherein executing the business logic is performed as a result of the entity prioritization.

15. The method of claim 10, wherein the relational structure comprises a hierarchical graph.

16. The method of claim 15, wherein the second entity comprises a parent node of the first entity.

17. The method of claim 15, wherein the first entity comprises a first node of the hierarchical graph and the business logic is associated with each node of the hierarchical graph that is related to the first node.

18. The method of claim 17, wherein the business logic includes a depth limit that defines a distance from the first node at which the business logic applies.

19. A computer program product comprising one or more computer readable media having stored thereon computer-executable instructions that are executable by one or more processors of a computer system to cause the computer system to execute business logic for an entity of a relational structure having a plurality of entities, the computer-executable instructions including instructions that are executable to cause the computer system to perform at least the following:
obtain data associated with a first entity of the plurality of entities of the relational structure, the obtained data at least partially causing actuation of a trigger;
based on actuation of the trigger, identify particular business logic associated with the trigger;
execute the business logic for a second entity that is related to the first entity within the relational structure, by using the obtained data associated with the first entity as a parameter value for execution of the business logic for the second entity; and
perform a computing action based on a result of executing the business logic for the second entity.

20. The computer program product in accordance with claim 15, wherein the computing action comprises execution of new business logic.
